(19) United States
(12) Patent Application Publication
(10) Pub. No.: US 2005/0138238 A1
(43) Pub. Date: Jun. 23, 2005

(54) Flow control interface

(76) Inventors: James Tierney, Carp (CA); David Stuart, Almonte (CA); Bradley Venables, Nepean (CA)

Correspondence Address: FISH & RICHARDSON PC, 225 FRANKLIN ST, BOSTON, MA, 02110, US

(21) Appl. No.: 10/745,270

(22) Filed: Dec. 22, 2003

(51) Int. Cl. G06F 3/00

(52) U.S. Cl. 710/33

(57) ABSTRACT

When a mode indicator indicates a first mode a flow of data segments to an access module is controlled by transmitting an identifier for a queue to the access module, receiving a signal indicating a status of the queue in response to transmitting the identifier, and transmitting data to the access module based on the status of the queue. When a mode indicator indicates a second mode a flow of data segments to an access module is controlled by receiving one or more signals indicating a status of a queue from the access module, and transmitting data to the access module based on the status of the queue.

### BACKGROUND

Data communications networks use flow control to regulate the flow of data and reduce congestion at various points within a network. Flow control is used between nodes in a network by sending messages across a transmission medium indicating when a data packet is ready to be received. Flow control is used between devices in a network by providing signals on control lines to indicate device status (e.g., a device buffer is full).

Network devices may use different protocols (e.g., based on different network layers). Some protocols (e.g., physical layer protocols such as SONET/SDH) handle input and output of a bit stream sent over a physical transmission medium (e.g., an optical fiber) and formatting of the bit stream (e.g., into frames). Other protocols (e.g., data link layer protocols such as High-level Data Link Control (HDLC)) handle encoding and decoding the bit stream, frame synchronization, and error checking.

Flow control between network devices is carried out through a device interface. Device interfaces define how data packets are exchanged between different devices (or parts of a device) that perform different network functions or use different protocols. The System Packet Interface (SPI) defines how data packets are transferred between a physical layer device (using a physical layer protocol) and a data link layer device (using a data link layer protocol). The SPI-3 interface defines control signals, sent between the physical layer and link layer devices, to mediate transfer of data packets over a data bus between the devices. The Common Switch Interface (CSIX) defines how data packets are transferred between a traffic manager device (that sends data to and receives data from a physical transmission medium) and a switch fabric device (that switches data packets among ports corresponding to different physical transmission media). In both SPI-3 and CSIX, the control signals include signals for flow control.

### SUMMARY

According to an aspect of the invention a method includes controlling a flow of data segments to an access module, when a mode indicator indicates a first mode, by transmitting an identifier for a queue to the access module, receiving a signal indicating a status of the queue in response to transmitting the identifier, and transmitting data to the access module based on the status of the queue. The method also includes controlling a flow of data segments to an access module, when a mode indicator indicates a second mode, by receiving one or more signals indicating a status of a queue from the access module, and transmitting data to the access module based on the status of the queue.

In general, in another aspect, the invention features an apparatus including a traffic manager including a first control module and a second control module, a physical access module in communication with the traffic manager over a first bus using a bus interface, and a fabric access module in communication with the traffic manager over a second bus using the bus interface. The first control module is in a first mode and configured to control a flow of data segments to the physical access module by transmitting an identifier for a first queue to the physical access module, receiving a signal indicating a status of the first queue in response to transmitting the identifier, and transmitting data to the physical access module based on the status of the first queue. The second control module is in a second mode and configured to control a flow of data segments to the fabric access module by receiving one or more signals indicating a status of a second queue from the fabric access module, and transmitting data to the fabric access module based on the status of the second queue.

In general, in another aspect, the invention features a system including a traffic manager including a first control module and a second control module, a physical access module in communication with the traffic manager over a first bus using a bus interface, a fabric access module in communication with the traffic manager over a second bus using the bus interface, one or more communication lines in communication with the physical access module, and a switch fabric in communication with the fabric access module. The first control module is in a first mode and configured to control a flow of data segments to the physical access module by transmitting an identifier for a first queue to the physical access module, receiving a signal indicating a status of the first queue in response to transmitting the identifier, and transmitting data to the physical access module based on the status of the first queue. The second control module is in a second mode and configured to control a flow of data segments to the fabric access module by receiving one or more signals indicating a status of a second queue from the fabric access module, and transmitting data to the fabric access module based on the status of the second queue.

In general, in another aspect, the invention features a processor including circuitry configured to control a flow of data segments to an access module, when a mode indicator indicates a first mode, by transmitting an identifier for a queue to the access module, receiving a signal indicating a status of the queue in response to transmitting the identifier, and transmitting data to the access module based on the status of the queue. The circuitry is also configured to control a flow of data segments to an access module, when a mode indicator indicates a second mode, by receiving one or more signals indicating a status of a queue from the access module, and transmitting data to the access module based on the status of the queue.

Embodiments of the invention may include one or more of the following features.

The first queue stores data packets for transmission on a first communication line. The first queue is in communication with the transmission module. The signal indicating the status of the first queue comprises a signal indicating whether an amount of data stored in the first queue is smaller or larger than a predetermined amount of data.

The second queue stores data packets to be switched from a first port of a switch fabric that is in communication with the fabric access module to a second port of the switch fabric. The data packets have the same priority class.

The signal indicating the status of the second queue comprises a signal indicating whether the switch fabric is accepting data from the second queue.

The signal indicating the status of the second queue comprises a signal indicating whether an amount of data stored in the second queue is smaller or larger than a predetermined amount.

The method also includes storing the status of the first queue in a state of a flag, and repeatedly transmitting the identifier for the first queue and updating the state of the flag based on a most recently received status of the first queue.

The first queue is one of a plurality of queues stored in a buffer in the physical access module.

The identifier for the first queue is repeatedly transmitted in a round-robin sequence along with identifiers for each of the plurality of queues.

Controlling the flow of data segments includes sending data segments of a data packet to the physical access module after determining the state of the flag.

The method also includes storing the status of the second queue in a state of a flag, and updating the state of the flag based on a most recently received status of the second queue.

The second queue is one of a plurality of queues stored in a buffer in the fabric access module.

The signal indicating the status of the second queue is sent from the fabric access module in response to congestion at the second port.

The signal indicating the status of the second queue further indicates the status of another of the plurality of queues.

Controlling the flow of data segments includes sending data segments of a data packet to the fabric access module after determining the state of the flag.

The bus interface is based on a System Packet Interface specification.

Embodiments of the invention may include one or more of the following advantages. A push flow control scheme is useful for the interface to the fabric access module to reduce the worst-case buffer size in the fabric access module. Using the same bus interface on both sides of the traffic manager simplifies the traffic management system. A queue identifier can identify a group of queues to enable the traffic manager to perform incremental flow control for a plurality of ports by turning off lower priority traffic while continuing to send higher priority traffic.

Other features and advantages of the invention will become apparent from the following description, and from the claims.

### DESCRIPTION OF DRAWINGS

FIG. 1 is a block diagram depicting a system for transferring data packets between a WAN network and a LAN network.

FIG. 2 is a block diagram of a portion of the traffic management system.

FIG. 3 is a block diagram of an interface between a physical access module and a traffic manager.

FIG. 4 is a block diagram of an interface between a traffic manager and a fabric access module.

### DESCRIPTION

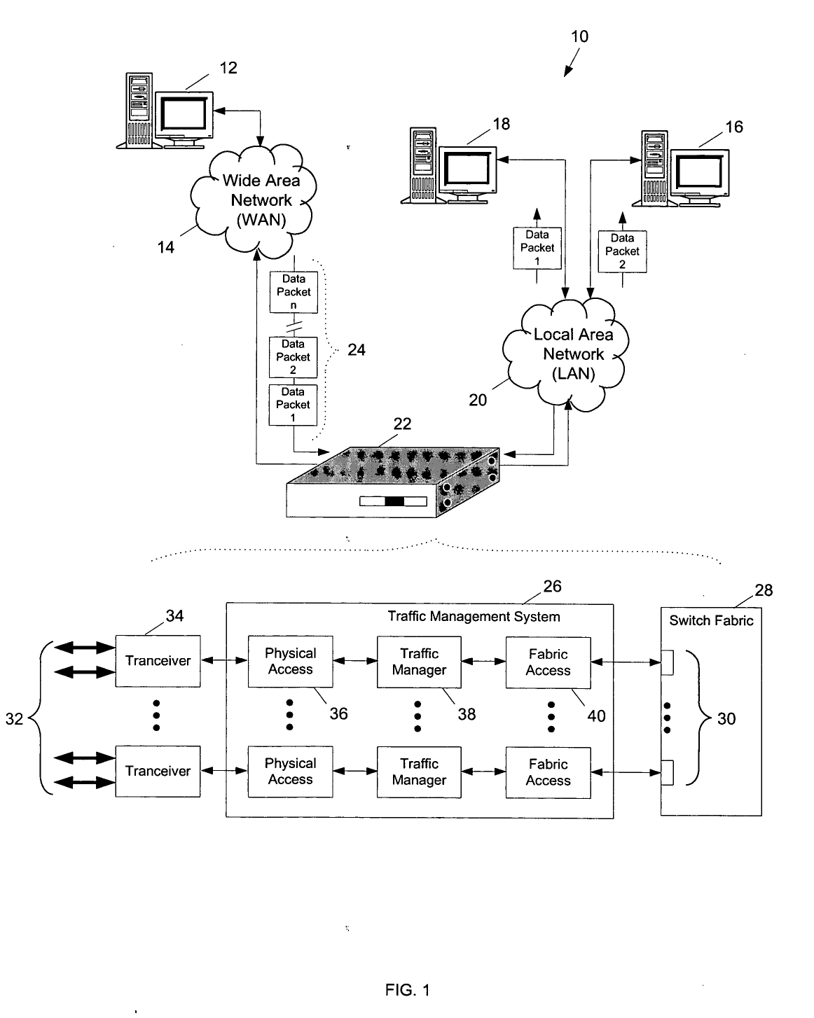

Referring to FIG. 1, a system 10 for transmitting data packets from a computer system 12 to other computer systems 16, 18 via a wide area network (WAN) 14 and a local area network (LAN) 20 includes a network device 22 (e.g., a switch or a router) that collects a stream of “n” data packets 24, and prepares each of the data packets for transmission through the LAN 20 and delivery to the appropriate destination computer system 16 or computer system 18. In this example, “data packet_{—}1” is transmitted from the computer system 12 for delivery to computer system 18 and “data packet_{—}2” is transmitted for delivery to computer system 16. To deliver the data packets to the appropriate computer system, the network device 22 includes a traffic management system 26 that processes the data packet stream 24.

In this example, the traffic management system 26 uses a switch fabric 28 having a set of ports 30 (e.g., 16 or 32 ports) to switch traffic among a set of physical communication lines 32 (e.g., optical fiber or Ethernet cable). The ports handle different types of traffic. For example, some of the ports are “access ports” for connecting to LANs such as LAN 20, and some of the ports are “trunk ports” typically having a larger bandwidth than the access ports for connecting to WANs such as WAN 14. The ports are bidirectional, handling both incoming “ingress” traffic and outgoing “egress” traffic (on separate lines).

An incoming data packet is received over one of the communication lines 32 by a transceiver 34. In the case of an optical fiber channel, the transceiver converts an incoming optical bit stream into an electronic bit stream. A transceiver handles a single communication line or a set of multiple communication lines. Each of the communication lines 32 is bidirectional, i.e., having separate transmit and receive optical fibers.

In this example, the traffic management system 26 includes a physical access module 36 that processes the electronic bit stream for a transceiver 34. The physical access module 36 extracts packets from the electronic bit stream for a receive mode and combines packets into the proper format (e.g., SONET/SDH frames) for a transmit mode. The physical access module also buffers ingress and egress traffic.

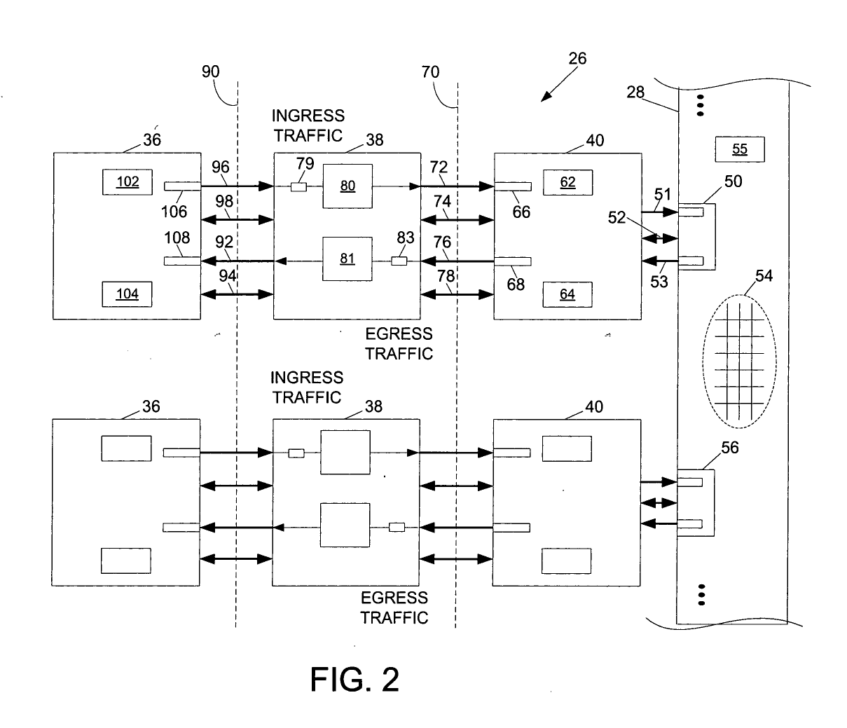

A traffic manager 38 handles tasks such as processing data packets received by the physical access module 36 according to a standard protocol (e.g., a data link layer protocol). The traffic manager 38 buffers data received from the physical access module 36 in an internal buffer 79 (FIG. 2). The traffic manager 38 forwards this data to the fabric access module 40 while respecting the flow control information received from the fabric access module 40. The traffic manager discards data if queues in its internal buffer 79 grow beyond set limits. The traffic manager 38 includes a dedicated control unit, such as a network processing unit (NPU), to perform these tasks. The traffic manager 38 has a control unit 80 for the ingress traffic and a control unit 81 for the egress traffic. Alternatively, the traffic manager 38 can have separate control units for interfacing with the physical access module 36 and the fabric access module 40, or a single control unit. Other arrangements are possible.

The traffic management system 26 also includes a fabric access module 40 (for each port) for buffering data packets and transferring data packets and control signals between the traffic management system 26 and the switch fabric 28.

Referring to FIG. 2, a portion of the traffic management system 26 is shown interfacing with the switch fabric 28. The switch fabric 28 has a port 50 that is in communication with a fabric access module 40. The port 50 communicates with the fabric access module over an interface that includes an input bus 51 for ingress traffic, a control bus 52 for control signals, and an output bus 53 for egress traffic. The switch fabric 28 includes a control module 54 that handles reading and writing of control signals and directing traffic arriving on an input bus of one port (e.g., port 50) through a switching core 55 to an output bus of another port (e.g., port 56).

The fabric access module 40 for port 50 includes a control unit 62 (e.g., a processor or an application specific integrated circuit (ASIC)) that handles traffic and control signals for the ingress direction and a control unit 64 that handles traffic and control signals for the egress direction. Ingress traffic arriving from the traffic manager 38 on a bus 72 is stored in an input buffer 66. The input buffer 66 is divided into separate queues, one for each of the other ports of the switch fabric 28. This allocation of memory resources in the input buffer 66 is useful for preventing many packets, which arrive for a busy port from using all of the buffer space in the input buffer 66 and consequently blocking traffic on other ports. An output buffer 68 stores packets from the switch fabric to send to the traffic manager 38 via bus 76. The output buffer 68 is divided into separate queues for multiple priority classes.

The physical access module 36 has a control unit 102 that handles traffic and control signals for the ingress direction and a control unit 104 that handles traffic and control signals for the egress direction. Ingress traffic arriving from a transceiver 34 is stored in an input buffer 106. A single transceiver 34 may handle multiple bidirectional communication lines 32. An output buffer 108 stores packets from the traffic manager 38 to send out on one of the communication lines 32 of the transceiver 34. The output buffer 108 is divided into separate queues for each of the communication lines 32.

The traffic manager 38 uses the control unit 80 to coordinate the flow of ingress traffic from the physical access module 36 to the fabric access module 40, and the control unit 81 to coordinate the flow of egress traffic from the fabric access module 40 to the physical access module 36. Ingress traffic is received over the bus 96, passed through a buffer 79 and a set of pipeline registers of the control unit 80, and output onto the bus 72. The traffic manager 38 uses control signals over control buses 98 and 74 to coordinate the transfer of data packets and to select a queue for each packet based on the packet's destination port. Egress traffic is received over the bus 76, passed through a buffer 83 and a set of pipeline registers of the control unit 81, and output onto the bus 92. The traffic manager 38 uses control signals over control buses 78 and 94 to coordinate the transfer of data packets and to select a queue for each packet based on the packet's destination communication line.

The control unit 80 handling the ingress traffic and the control unit 81 handling the egress traffic are each dual mode devices that have a mode indicator (e.g., a mode selection bit) to indicate either a “polling flow control mode” or a “push flow control mode.” The control units 80 and 81 use the same pin configuration for connecting to a common bus interface.

The traffic manager 38 uses a common bus interface for the interface 90 between the traffic manager 38 and the physical access module 36, and for the interface 70 between the traffic manager 38 and the fabric access module 40. The control unit 81 that transmits egress traffic to the physical access module 36 is set to the polling flow control mode to support a standards based flow control scheme (e.g., polling flow control based on the System Packet Interface Level 3 (SPI-3) specification from the Optical Internetworking Forum, or based on the ATM Forum af_phy-0136/UTOPIA L3, or the ATM Forum af-phy-0143 also knows as POS_PHY Level 3), as described in more detail below. The control unit 81 that transmits ingress traffic to the fabric access module 40 is set to the push flow control mode to support a flow control scheme suited for the properties of the switch fabric 28, as described in more detail below. Alternatively, the control units 80 and 81 can each be single mode devices that support the push flow control mode over a standards based interface that normally uses polling flow control to manage data transfer.

In this example, the bus interface that the traffic manager 38 uses is based on the SPI-3 specification. This common bus interface determines the configuration of the data bus and control bus and the timing of the signals sent over the buses. The SPI-3 interface specification governs the exchange of data packets between a physical layer side and a link layer side. In this example, for the interface 90, the traffic manager 38 performs the functions on the link layer side of the interface 90 and the physical access module 36 performs the functions of the physical layer side.

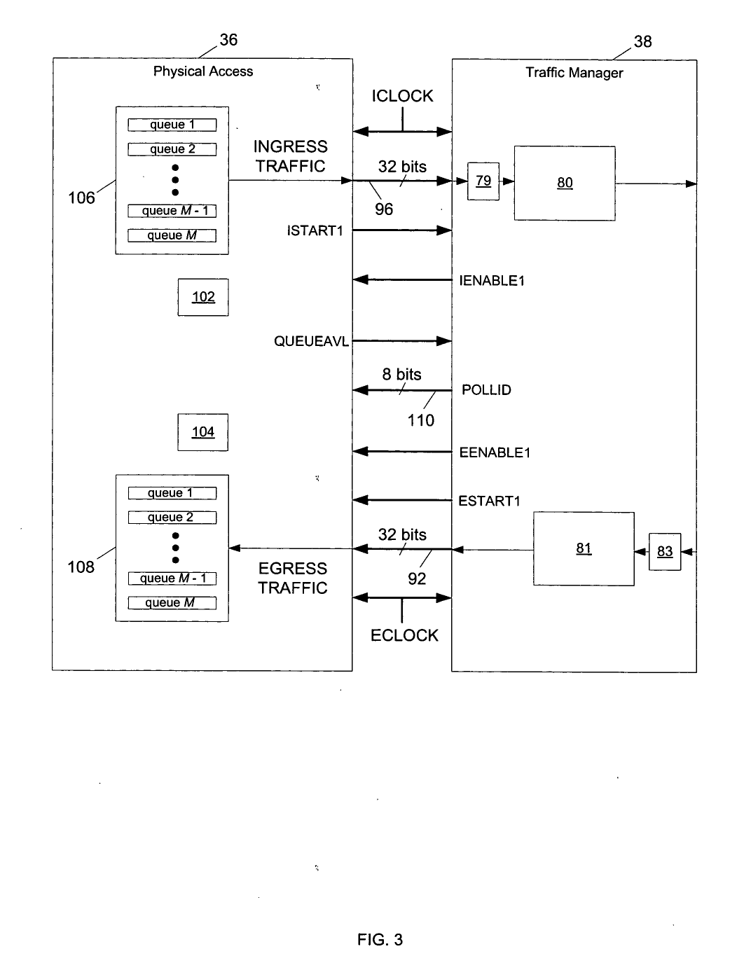

Referring to FIG. 3, the physical access module 36 stores incoming data packets in the input buffer 106 in M input queues, where M is the number of communication lines connected to the physical access module 36. Each queue holds a limited number of data packets. The physical access module 36 sends a data packet to the traffic manager 38 from each of the input queues in a round-robin sequence. A clock signal ICLOCK is used to synchronize the transfer of ingress traffic, and a clock signal ECLOCK is used to synchronize the transfer of egress traffic. A data packet is sent over the data bus 96 in segments of up to 32 bits each clock cycle.

In this example, binary control signals are “asserted” by driving a high voltage onto the control bus line and “deasserted” by driving a low voltage onto the control bus line.

For ingress traffic from the physical access module 36, the traffic manager 38 asserts the IENABLE1 signal to indicate that the traffic manager 38 is ready to receive a packet. After the physical access module 36 samples the IENABLE1 signal (on the rising edge of the ICLOCK signal) and detects the signal asserted, the physical access module 36 identifies a communication line, and the corresponding input queue from which the packet is being read, by sending an identifier “in-band” over the data bus 96. The physical access module 36 asserts the ISTART1 signal to notify the traffic manager 38 to read the queue identifier on the data bus 96. The physical access module 36 deasserts the ISTART1 signal and sends segments of a data packet from the identified queue over the data bus 96 in subsequent clock cycles. The ISTART1 signal is asserted when the queue identifier is on the data bus 96 and deasserted when the packet segments are on the data bus 96. The traffic manager 38 can pause the data flow by deasserting the IENABLE1 signal.

For egress traffic, the traffic manager 38 determines whether an output queue in the output buffer 108 has space available to receive a packet to be sent out over the corresponding communication line. The traffic manager 38 polls the output queues of the physical access module 36 in a round-robin sequence by sending the queue identifier over the POLLID bus 110. In this example, the POLLID bus 110 is 8 bits wide to support up to 256 input queues and communication lines. This polling scheme provides flow control allowing the traffic manager 38 to determine those output queues that are congested.

After the physical access module 36 samples the POLLID identifier (on the rising edge of the ECLOCK signal), the physical access module 36 updates the QUEUEAVL signal with the status of the output queue identified by POLLID. If a predefined minimum number of bytes is available in the identified output queue then the physical access module 36 asserts the QUEUEAVL signal, otherwise the physical access module 36 deasserts the QUEUEAVL signal. The predefined number of bytes is a threshold that can be programmed by a user. Considerations that are used to determine the threshold are the rate of the transfer clock (ECLOCK), the size of the segments passed over the interface, and the polling rate.

The traffic manager 38 stores a flag for each output queue representing the queue's status. The traffic manager 38 updates the status flags as it polls the output queue status in a round-robin sequence. If the traffic manager 38 samples the QUEUEAVL signal asserted (during a subsequent clock cycle) then the status flag is set. If the traffic manager samples the QUEUEAVL signal deasserted then the status flag is cleared.

To determine the status of an output queue, the traffic manager 38 reads the status flag for that output queue. The control unit 81 in the traffic manager 38 typically performs this read operation much faster than the time it takes to poll an output queue. The traffic manager 38 is therefore able to transfer a packet without having to wait to poll the output queue. If the flag has changed but has not been updated, there is enough space available in an output queue to absorb further packet segments sent by the traffic manager 36.

After the traffic manager 38 determines that a status flag is set for particular output queue, the traffic manager 38 asserts the EENABLE1 signal to indicate that the traffic manager 38 is ready to transmit a packet to the physical access module 36. The traffic manager 38 identifies a communication line, and the corresponding output queue into which the packet is to be written, by sending an identifier over the data bus 92. The traffic manager 38 asserts the ESTART1 signal to notify the physical access module 36 to read the queue identifier on the data bus 92. The traffic manager 38 deasserts the ESTART1 signal and sends segments of a data packet for the identified queue over the data bus 92 in subsequent clock cycles.

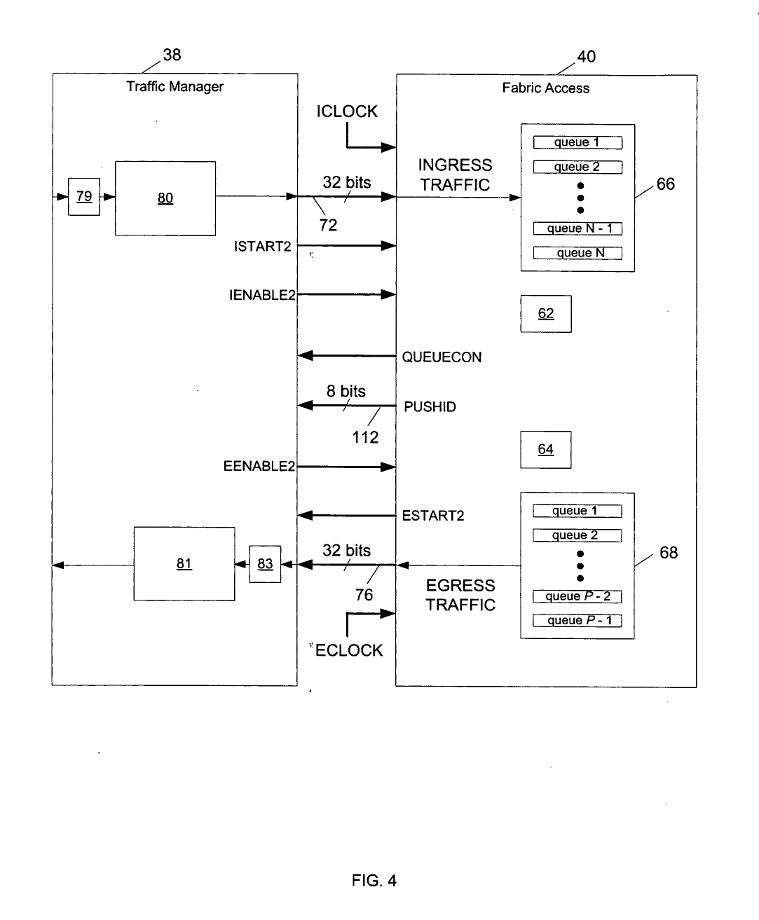

For the interface 90 (FIG. 3), the traffic manager 38 receives ingress traffic from the physical access module 36 and transmits egress traffic to the physical access module 36. For the interface 70 to be described below with reference to FIG. 4, the traffic manager 38 transmits ingress traffic to the fabric access module 40 and receives egress traffic from the fabric access module 40.

Since there are potentially many other traffic managers 38 in the traffic management system 26 that are sending data packets to the switch fabric 28 (via a fabric access module 40), there may be congestion if a burst of data packets from many switch fabric ports are switched to the same switch fabric port output bus. This leads to variable bandwidth characteristics for the interface 70 leading to the switch fabric 28.

While the “polling flow control” scheme described above may be appropriate for the interface 90 leading to the communication lines with more predictable bandwidth characteristics, a flow control scheme with shorter latency may be more appropriate for the interface 70 to the fabric access module 40 to reduce the worst-case buffer size in the fabric access module 40. Instead of using a different bus interface to provide flow control to the switch fabric 28, the traffic manager 38 uses the same bus interface for the fabric access module 40 as for the physical access module 36 (in this case, based on the SPI-3 interface specification) for sending and receiving data packets, and uses a modified event based “push flow control” scheme that has a shorter latency (as explained in more detail below). Using the same bus interface on both sides of the traffic manager 38 simplifies the traffic management system 26.

The push flow control scheme also supports flow control based on priority classes. If packets are labeled (e.g., by bits in a header) according to a set of priority classes (e.g., four priority classes labeled by two priority bits) then the traffic manager 38 can perform incremental flow control by turning off lower priority traffic while continuing to send higher priority traffic.

Referring to FIG. 4, for the fabric interface 70, the traffic manager 38 performs the functions on the link layer side of the interface 70 and the fabric access module 40 performs the functions of the physical layer side. The fabric access module 40 stores data packets sent from the traffic manager 38 in a buffer 66 organized into a set of N queues. There is a separate queue for each switch fabric port to which a packet may be switched and for each priority class. If the switch fabric 28 has P ports and there are C priority classes, then the number of queues in the buffer 66 is: N=CP (which includes queues for traffic that is not switched, or sent back out of the same switch fabric port that the traffic enters).

The fabric access module 40 also has a buffer 68 for storing packets arriving from the switch fabric 28. This buffer 68 has C queues for the C priority classes. The fabric access module 40 sends a data packet to the traffic manager 38 from each of the queues in buffer 68 based on priority. The clock signals ICLOCK and ECLOCK used by the physical access module 36 and the traffic manager 38 are also used to synchronize the traffic to and from the fabric access module 40.

For egress traffic from the fabric access module 40, the traffic manager 38 asserts the EENABLE2 signal to indicate that the traffic manager 38 is ready to receive a packet. After the fabric access module 40 samples the EENABLE2 signal (on the rising edge of the ECLOCK signal) and detects the signal asserted, the fabric access module 40 identifies a queue from which the packet is being read by sending an identifier over the data bus 76. The fabric access module 40 asserts the ESTART2 signal to notify the traffic manager 38 to read the queue identifier on the data bus 76. The fabric access module 40 deasserts the ESTART2 signal and sends segments of a data packet from the identified queue over the data bus 76 in subsequent clock cycles. The ESTART2 signal is asserted when the queue identifier is on the data bus 76 and deasserted when the packet segments are on the data bus 76. The traffic manager 38 can pause the data flow by deasserting the EENABLE2 signal.

For ingress traffic, the traffic manager 38 determines whether a queue in the buffer 66 has space available to receive a packet to be sent out to the corresponding switch fabric port based on push flow control information. For the fabric interface 70, the traffic manager 38 uses a local flag to determine the status of a queue, where the flag is updated based on flow control event information “pushed” to the traffic manager 38 from the fabric access module 40.

For example, when a particular switch fabric port becomes congested (e.g., due to filling of buffer space in the switch fabric 28 for data packets leaving the fabric on the output bus for that port), the switch fabric 28 notifies the fabric access modules 40 (over a control bus 52) to stop sending data for that port to the fabric. For incremental flow control, the switch fabric 28 first notifies the fabric access modules 40 to stop sending low-priority traffic when the buffer reaches a low-priority threshold. As the buffer reaches higher priority thresholds, the switch fabric 28 stops higher priority traffic. Likewise, when a particular switch fabric port is no longer congested, the switch fabric 28 notifies the fabric access modules 40 to start sending data to the fabric again.

Different priority-based flow control schemes can be used at the switch fabric 28. The switch fabric 28 may stop low-priority traffic for a single congested port, or for all ports at the same time.

This change in congestion of ports in the switch fabric 28 leads to flow control event information being sent to the traffic manager 38. The fabric access module 40 sends the flow control event information to the traffic manager 38 based on control signals from the switch fabric 28. The fabric access module 40 sends a queue identifier over the PUSHID bus 112, and a status indicator over the bus line for the QUEUECON signal. The queue identifier identifies a single queue (e.g., for a particular port and priority) or a group of queues (e.g., for a particular priority for all ports, or for a particular port for all priorities). The fabric access module 40 asserts the QUEUECON signal to indicate that the identified queue or queues are congested and should be flow controlled off, or deasserts the QUEUECON signal to indicate that the queue or queues are not congested and should be flow controlled on.

Alternatively, the flow control event information can be based on status changes in the fabric access module 40. A queue for a particular switch fabric port and priority class that has stopped sending to the fabric will start to build up data packets. When the number of packets in the queue crosses a high level, the fabric access module 40 sends a queue identifier for that queue to the traffic manager 38 over the PUSHID bus 112 and asserts the QUEUECON signal. After the fabric access module 40 starts sending packets from that queue again and the number of packets drops below a low level, the fabric access module 40 sends a queue identifier for that queue to the traffic manager 38 and deasserts the QUEUECON signal.

The traffic manager 38 stores a flag for each of the N queues representing the queue's status. The traffic manager 38 updates the status flags as it receives an identifier for one or more queues over the PUSHID bus 112. If the traffic manager 38 samples the QUEUECON signal asserted (during a subsequent clock cycle) then the status flag for the identified queue or group of queues is set. If the traffic manager samples the QUEUECON signal deasserted then the status flag is cleared.

To determine the status of an output queue, the traffic manager 38 reads the status flag for that output queue. Since the flag is being updated based on flow control events, there is shorter flow control latency and therefore less space is needed in a queue to absorb further packet segments sent by the traffic manager 36 in a worst-case scenario.

After the traffic manager 38 determines that a status flag is clear for the particular queue (indicating that the queue is not congested), the traffic manager 38 asserts the IENABLE2 signal to indicate that the traffic manager 38 is ready to transmit a packet to the fabric access module 40. The traffic manager 38 identifies a queue into which the packet is to be written, by sending an identifier over the data bus 72. The traffic manager 38 asserts the ISTART2 signal to notify the fabric access module 40 to read the queue identifier on the data bus 72. The traffic manager 38 deasserts the ISTART2 signal and sends segments of a data packet for the identified queue over the data bus 72 in subsequent clock cycles.

For each of the interfaces 70 and 90, the traffic manager 38 also uses other control signals for (over bus lines not shown) for functions such as identifying the first and last segment of a packet and indicating errors in a packet.

Other embodiments are within the scope of the following claims.

1. A method comprising:
controlling a flow of data segments to an access module, when a mode indicator indicates a first mode, by
transmitting an identifier for a queue to the access module;
receiving a signal indicating a status of the queue in response to transmitting the identifier; and
transmitting data to the access module based on the status of the queue; and
controlling a flow of data segments to an access module, when a mode indicator indicates a second mode, by
receiving one or more signals indicating a status of a queue from the access module; and
transmitting data to the access module based on the status of the queue.

2. The method of claim 1 wherein the one or more signals indicating a status of a queue comprise:
an identifier for a queue; and
a signal indicating a status of the identified queue.

3. The method of claim 1 wherein the queue stores data packets to be transmitted on a communication line.

4. The method of claim 1 wherein the signal indicating the status of the queue comprises a signal indicating whether an amount of data stored in the queue is larger than a predetermined amount.

5. The method of claim 1 wherein the signal indicating the status of the queue comprises a signal indicating whether an amount of storage space available in the queue is smaller than a predetermined amount.

6. The method of claim 1 wherein the queue stores data packets to be switched from a first port of a switch fabric to a second port of the switch fabric.

7. The method of claim 6 wherein the data packets have the same priority class.

8. The method of claim 6 wherein the one or more signals indicating the status of the queue comprises a signal indicating whether the switch fabric is accepting data from the queue.

9. The method of claim 1 wherein the one or more signals indicating the status of the queue comprise a signal indicating whether an amount of data stored in the queue is larger than a predetermined amount.

10. The method of claim 1 wherein the one or more signals indicating the status of the queue comprise a signal indicating whether an amount of storage space available in the queue is smaller than a predetermined amount.

11. An apparatus comprising:
a traffic manager including a first control module and a second control module;
a physical access module in communication with the traffic manager over a first bus using a bus interface; and
a fabric access module in communication with the traffic manager over a second bus using the bus interface;
with the first control module in a first mode and configured to control a flow of data segments to the physical access module by
transmitting an identifier for a first queue to the physical access module;
receiving a signal indicating a status of the first queue in response to transmitting the identifier; and
transmitting data to the physical access module based on the status of the first queue; and
with the second control module in a second mode and configured to control a flow of data segments to the fabric access module by
receiving one or more signals indicating a status of a second queue from the fabric access module; and
transmitting data to the fabric access module based on the status of the second queue.

12. The apparatus of claim 11 wherein the one or more signals indicating a status of a queue comprise:
an identifier for a queue; and
a signal indicating a status of the identified queue.

13. The apparatus of claim 1 1 wherein the signal indicating the status of the first queue comprises a signal indicating whether an amount of data stored in the first queue is larger than a predetermined amount.

14. The apparatus of claim 11 wherein the signal indicating the status of the first queue comprises a signal indicating whether an amount of storage space available in the first queue is smaller than a predetermined amount.

15. The apparatus of claim 11 wherein the second queue stores data packets to be switched from a first port of a switch fabric that is in communication with the fabric access module to a second port of the switch fabric.

16. The apparatus of claim 1 1 wherein the one or more signals indicating the status of the second queue comprise a signal indicating whether an amount of data stored in the second queue is larger than a predetermined amount.

17. The apparatus of claim 11 wherein the one or more signals indicating the status of the second queue comprises a signal indicating whether an amount of storage space available in the first queue is smaller than a predetermined amount.

18. The apparatus of claim 11 wherein the traffic manager is further configured to:
store the status of the first queue in a state of a flag; and
repeatedly transmit the identifier for the first queue and updating the state of the flag based on a most recently received status of the first queue;
wherein the first queue is one of a plurality of queues stored in a buffer in the physical access module, and the identifier for the first queue is repeatedly transmitted in a round-robin sequence along with identifiers for each of the plurality of queues.

19. The apparatus of claim 15 wherein the traffic manager is further configured to
store the status of the second queue in a state of a flag; and
update the state of the flag based on a most recently received status of the second queue;
wherein the second queue is one of a plurality of queues stored in a buffer in the fabric access module, and the signal indicating the status of the second queue is sent from the fabric access module in response to congestion at the second port.

20. The apparatus of claim 11 wherein the bus interface is based on a System Packet Interface specification.

21. An system comprising:
a traffic manager including a first control module and a second control module;
a physical access module in communication with the traffic manager over a first bus using a bus interface;
a fabric access module in communication with the traffic manager over a second bus using the bus interface;
one or more communication lines in communication with the physical access module; and
a switch fabric in communication with the fabric access module;
with the first control module in a first mode and configured to control a flow of data segments to the physical access module by
transmitting an identifier for a first queue to the physical access module;
receiving a signal indicating a status of the first queue in response to transmitting the identifier; and
transmitting data to the physical access module based on the status of the first queue; and
with the second control module in a second mode and configured to control a flow of data segments to the fabric access module by
receiving one or more signals indicating a status of a second queue from the fabric access module; and
transmitting data to the fabric access module based on the status of the second queue.

22. The system of claim 21 wherein the signal indicating the status of the first queue comprises a signal indicating whether an amount of data stored in the first queue is larger than a predetermined amount.

23. The system of claim 21 wherein the signal indicating the status of the first queue comprises a signal indicating whether an amount of storage space available in the first queue is smaller than a predetermined amount.

24. The system of claim 21 wherein the second queue stores data packets to be switched from a first port of a switch fabric that is in communication with the fabric access module to a second port of the switch fabric.

25. The system of claim 21 wherein the signal indicating the status of the second queue comprises a signal indicating whether an amount of data stored in the second queue is larger than a predetermined amount.

26. The system of claim 21 wherein the signal indicating the status of the second queue comprises a signal indicating whether an amount of storage space available in the first queue is smaller than a predetermined amount.

27. A processor comprising:
circuitry configured to
control a flow of data segments to an access module, when a mode indicator indicates a first mode, by
transmitting an identifier for a queue to the access module;
receiving a signal indicating a status of the queue in response to transmitting the identifier; and
transmitting data to the access module based on the status of the queue; and
control a flow of data segments to an access module, when a mode indicator indicates a second mode, by
receiving one or more signals indicating a status of a queue from the access module; and
transmitting data to the access module based on the status of the queue.

28. The processor of claim 27 wherein the signal indicating the status of the queue comprises a signal indicating whether an amount of data stored in the queue is larger than a predetermined amount.

29. The processor of claim 27 wherein the signal indicating the status of the queue comprises a signal indicating whether an amount of storage space available in the queue is smaller than a predetermined amount.

30. A method comprising:
controlling a flow of data segments to an access module using push flow control over a standards based interface that normally uses polling flow control to manage data transfer.

31. The method of claim 30 wherein the standards based interface comprises System Packet Interface Level 3.

32. An apparatus comprising:
an access module;
a control module configured to control a flow of data segments to the access module using push flow control over a standards based interface that normally uses polling flow control to manage data transfer.

33. The apparatus of claim 32 wherein the standards based interface comprises System Packet Interface Level 3.
